(19) United States
(12) Patent Application Publication
(10) Pub. No.: US 2008/0016892 A1
(43) Pub. Date: Jan. 24, 2008

(54) Air conditioner for vehicles

(76) Inventors: Kilsang Jang, Daejeon-si (KR); Yongjun Jee, Daejeon-si (KR)

Correspondence Address: FULBRIGHT & JAWORSKI, LLP, 666 FIFTH AVE, NEW YORK, NY, 10103-3198, US

(21) Appl. No.: 11/879,620

(22) Filed: Jul. 18, 2007

(30) Foreign Application Priority Data
Jul. 21, 2006 (KR) 10-2006-0068682
Jul. 9, 2007 (KR) 10-2007-0068603

(51) Int. Cl. B60H 1/32

(52) U.S. Cl. 62/244

(57) ABSTRACT

The present invention relates to an air conditioner for vehicles, and more particularly, to an air conditioner for vehicles, in which a seat vent is formed on an air-conditioning case to supply some of air existing in a mixing area formed inside the air-conditioning case to the seat and a heat exchanger for seat is also mounted in the air-conditioning case, thereby securing an installation space for installing convenient devices inside a seat, and in which the air conditioner is utilized to cool and heat the seat, thereby reducing consumption of energy by enhancing efficiency, decreasing the number of components since additional temperature-adjusting door is not needed, and supplying a fixed amount of air to the seat regardless of air-conditioning modes.

This application claims priority from Korean Patent Application No. 10-2006-0068682 filed Jul. 21, 2006 and Korean Patent Application No. 10-2007-0068603 filed Jul. 9, 2007, each of which are incorporated herein by reference in their entireties.

### BACKGROUND OF THE INVENTION

1. Field of the Invention

The present invention relates to an air conditioner for vehicles, and more particularly, to an air conditioner for vehicles, in which a seat vent is formed on an air-conditioning case to supply some of air existing in a mixing area formed inside the air-conditioning case to the seat and a heat exchanger for seat is also mounted in the air-conditioning case, thereby securing an installation space for installing convenient devices inside a seat, and in which the air conditioner is utilized to cool and heat the seat, thereby reducing consumption of energy by enhancing efficiency, decreasing the number of components since additional temperature-adjusting door is not needed, and supplying a fixed amount of air to the seat regardless of air-conditioning modes.

2. Background Art

In general, an air conditioner for vehicles is a car interior component, which is installed in the vehicle for the purpose of cooling/heating the inside of the vehicle in the summer season or the winter season or removing frost from a windshield in rainy season or winter season to thereby secure a driver's front and rear visual field. Since such an air conditioner typically includes a heating device and a cooling device together, it heats, cools or ventilates the inside of the vehicle through the steps of selectively introducing the indoor air or the outdoor air to the air conditioner through a blower unit, heating or cooling the introduced air, and blowing the heated or cooled air into the vehicle.

Such an air conditioner is classified into a three-piece type where a blower unit, an evaporator unit, and a heater core unit are disposed independently, a semi-center type where the evaporator unit and the heater core unit are embedded in an air-conditioning case and the blower unit is mounted separately, and a center-mounting type where the three units are all embedded in the air-conditioning case.

The air conditioner is generally divided into a front air conditioner for air-conditioning the front seat and a rear air conditioner for air-conditioning the rear seat.

In addition, a seat air conditioner for vehicles have been in various forms proposed, which is in link with the front air conditioner to cool and heat the seat of the vehicle by bypassing heat-exchanged air from the front air conditioner toward the front seat of the vehicle to thereby make a passenger's back and hips agreeable. FIG. 1 illustrates an example (Japanese Patent Laid-Open Publication No. 1999-263116 (on Sep. 28, 1999)) of the seat air conditioner for the vehicles.

As shown in FIG. 1, the seat air conditioner for the vehicles includes: a connection duct 30 connected from an air-conditioning case 21 of a front air conditioner 20 to a vehicle seat 10; and a blower 40 and an auxiliary heat exchanger 50 mounted in a space, where the vehicle seat 10 is mounted, and, which is the downstream side of the connection duct 30.

Moreover, a ventilation passageway 12 is formed on the vehicle seat 10 to discharge air toward a passenger, and the connection duct 30 is connected to the ventilation passageway 12, so that air can be effectively blown from an air discharge port of the air-conditioning case 21 toward the ventilation passageway 12 through the connection duct 30 by an operation of the blower 40.

However, the seat air conditioner for vehicles according to the prior art has several problems in that it is insufficient in heating and cooling performances since the air conditioner must use a small-sized device due to a lack of the inner space of the seat 10, and in that the manufacturing cost increases since each seat 10 needs its own seat air conditioner and finally one vehicle needs several seat air conditioners.

Furthermore, the seat air conditioner for vehicles according to the prior art has additional problems in that there is a spatial limitation in installing other devices since the seat air conditioner occupies a large area inside the seat 10, in that the quantity of components is increased since the same parts are mounted in each seat 10, and in that it is inconvenient to assemble the air conditioner since the components occupy a large space.

### SUMMARY OF THE INVENTION

Accordingly, the present invention has been made to solve the above-mentioned problems occurring in the prior arts, and it is an object of the present invention to provide an air conditioner for vehicles, in which a seat vent is formed on an air-conditioning case to supply some of air existing in a mixing area formed inside the air-conditioning case to the seat and a heat exchanger for seat is also mounted in the air-conditioning case, thereby securing an installation space for installing convenient devices inside a seat, and in which, the air conditioner is utilized to cool and heat the seat, thereby reducing consumption of energy by enhancing efficiency, decreasing the number of components since additional temperature-adjusting door is not needed, cooling and heating a number of the seats using one heat exchanger for seat and one blower for seat, and supplying a fixed amount of air to the seat regardless of air-conditioning modes.

To accomplish the above objects, according to the present invention, there is provided an air conditioner for vehicles, which includes: an air-conditioning case having an air introduction port formed at an inlet thereof and a defrost vent, a face vent and a floor vent formed at an outlet thereof; and an evaporator and a heater core mounted inside the air-conditioning case. The air-conditioning case has a seat vent formed at the outlet thereof for supplying some of air existing in a mixing area, where air passing through the evaporator and air passing through the heater core are mixed with each other, to a seat of the vehicle.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view of a seat air conditioner for vehicles according to a prior art;

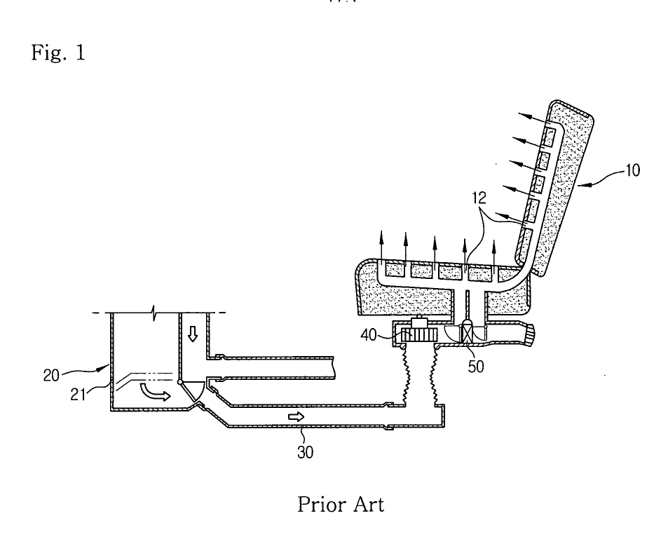

FIG. 2 is a structural view of an air conditioner for vehicles according to the present invention;

FIG. 3 is a perspective view showing a state where the air conditioner according to the present invention is connected with a vehicle seat through a seat duct;

FIG. 4 is a sectional view of the air conditioner according to the present invention; and

FIG. 5 is a perspective view showing a state where a blower for seat is mounted to the seat duct in the air conditioner according to the present invention.

### DETAILED DESCRIPTION OF THE PREFERRED EMBODIMENT

Reference will be now made in detail to the preferred embodiment of the present invention with reference to the attached drawings.

Repeated descriptions of the same configuration and action as the prior art will be omitted.

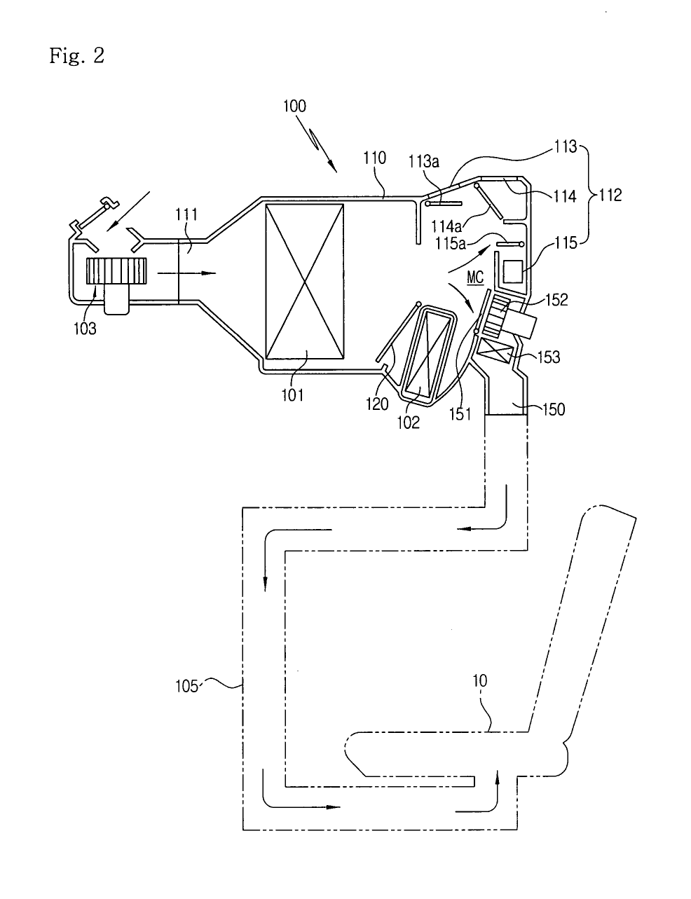

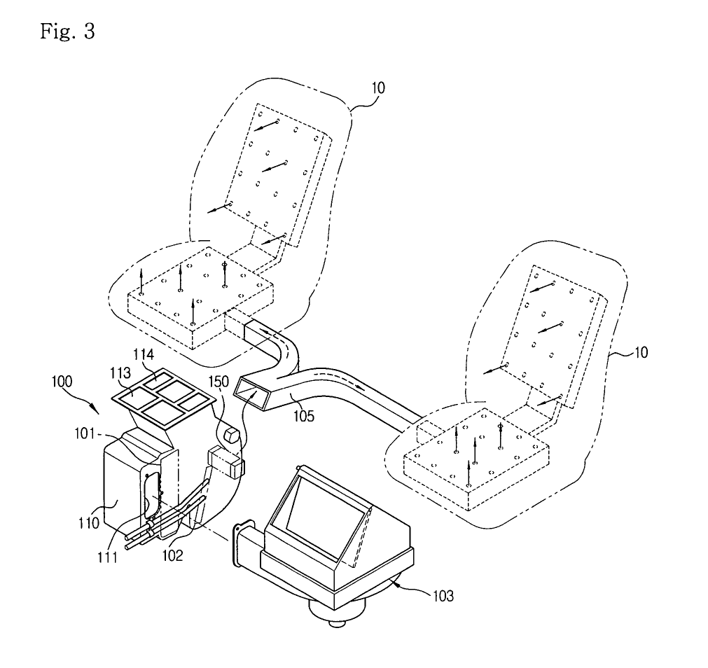

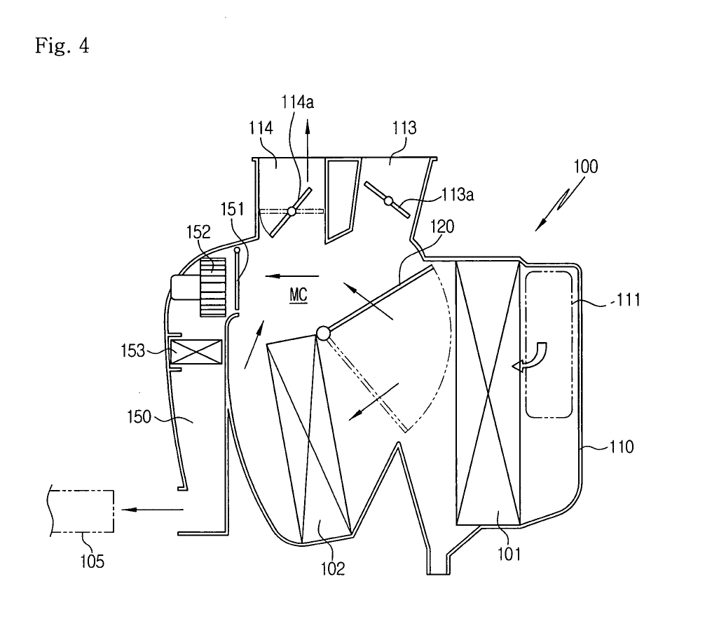

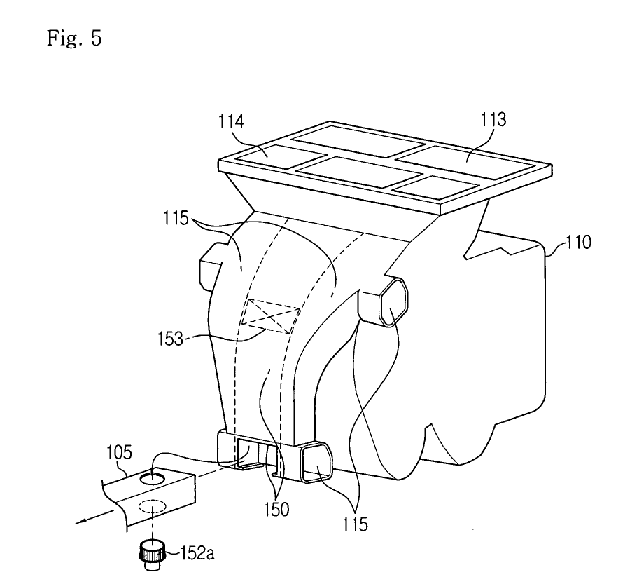

FIG. 2 is a structural view of an air conditioner for vehicles according to the present invention, FIG. 3 is a perspective view showing a state where the air conditioner is connected with a vehicle seat through a seat duct, FIG. 4 is a sectional view of the air conditioner, and FIG. 5 is a perspective view showing a state where a blower for seat is mounted to the seat duct in the air conditioner.

As shown in the drawings, the air conditioner for vehicles according to the present invention includes an air conditioner 100 for air-conditioning the front seat of the vehicle; and a heat exchanger for seat 153 and a blower for seat 152 mounted integrally with the air conditioner 100 for heating and cooling a seat 10.

The air conditioner 100 includes an air-conditioning case 110 having an air introduction port 111 formed at an inlet thereof and a number of air discharge ports 112 formed at an outlet thereof.

Here, the air discharge port 112 includes a defrost vent 113 for discharging air toward the front window of the vehicle, a face vent 114 for discharging air toward a passenger's face, and a floor vent 115 for discharging air toward the passenger's feet. So, the vents 113, 114 and 115 are controlled in a degree of their opening while being opened or closed by mode doors 113a, 114a and 115a to thereby perform one of various air-conditioning modes (a vent mode, a floor mode, a defrost mode, a bi-level mode, or a mix mode).

An evaporator 101 and a heater core 102 are mounted inside the air-conditioning case 110 in order and spaced apart from each other at a predetermined interval, and a temperature-adjusting door 120 is mounted between the evaporator 101 and the heater core 102 for adjusting an amount that cold air passing through the evaporator 101 and hot air passing through the heater core 102 are mixed with each other.

Meanwhile, a blower 103 is mounted at the air introduction port 111 of the air-conditioning case 110 to blow the indoor air or the outdoor air to the inside of the air-conditioning case 110.

In addition, a seat vent 150 is formed at the outlet of the air-conditioning case 110 for supplying some of air existing in a mixing area (MC), where air passing through the evaporator 101 and air passing through the heater core 102 are mixed with each other, to the seat 10.

The seat vent 150 is formed on a side of the floor vent 115, namely, partitionally formed between the right and left sides of the floor vent 115 in such a manner that the floor vent is partitioned into the right and left sides.

Here, an inlet of the seat vent 150 is adjacent to the mixing area (MC), where the cold air passing through the evaporator 101 and the hot air passing through the heater core 102 are mixed with each other, and formed on the downstream side of the mixing area (MC).

As described above, the air conditioner according to the present invention supplies the air existing in the mixing area (MC), where the air passing through the evaporator 101 and the air passing through the heater core 102 are mixed with each other, to the seat 10, and so, can supply a fixed amount of air regardless of air-conditioning modes and without needing additional temperature-adjusting door for adjusting temperature of the air supplied to the seat 10.

Furthermore, the heat exchanger for seat 153 is mounted inside the seat vent 150 for heating and cooling the seat 10 by heat-exchanging air passing through the seat vent 150.

The heat exchanger for seat 153 may be a heat exchanger, which has at least one of a heating function and a cooling function, namely, it is preferable that a PTC heater (not shown) or a thermoelement module (not shown) is used for the heat exchanger for seat 153.

So, the temperature-adjusting door 120 mounted inside the air-conditioning case 110 can first adjust temperature of the air supplied to the seat 10, and an insufficient load of cooling or heating can be additionally replenished by the heat exchanger for seat 153.

Moreover, the evaporator 101, the heater core 102 and the heat exchanger for seat 153 can be all mounted inside the air-conditioning case 110, so that the air conditioner can be modulated and improve productivity.

Meanwhile, an example where the PTC heater is mounted as the heat exchanger for seat 153 will be described. When a high-speed heating is difficult at a low temperature in the winter season, electric power is supplied to the PTC heater, and so, the seat 10 can be rapidly supplied with warm air.

Additionally, when it is necessary to cool the inside of the vehicle in the summer season, the seat 10 can be cooled using cold air passing through the evaporator 101 of the air conditioner 100.

In this instance, if the passenger wants just the air blown from the air conditioner 100, the air conditioner supplies some of the air existing in the cold air and hot air mixing area (MC) of the air-conditioning case 110 to the seat 10. The PTC heater is actuated to adjust temperature when the air existing in the cold air and hot air mixing area (MC) is too cold and needs to be heated.

In addition, an example where the thermoelement module, which can provide all of the heating and cooling functions, is mounted as the heat exchanger for seat 153 will be described. The thermoelement module includes a thermoelement (not shown), which performs a heat-absorbing action at one side and a heat-generating action at the other side according to a flow direction of electric current, and heat-exchange pins (not shown) mounted at both sides of the thermoelement.

Since the thermoelement module can perform the heat-absorbing action and the heat-generating action simultaneously through conversion of the positive pole (+) and the negative pole (−) of electric current, the thermoelement module can heat or cool the seat 10 by supplying hot air or cold air to the seat 10 after heating or cooling the air passing through the seat vent 150. That is, since the heat-exchange pins located at a passageway of the seat vent 150 can be cooled or heated when the pole of the electric current applied to the thermoelement is converted, the thermoelement module can convert the cooling function into the heating function and the heating function into the cooling function. So, the passenger can select the heating function and the cooling function by manipulating a heating and cooling switch (not shown).

Meanwhile, since the cooling performance and the heating performance of the air conditioner 100 are all insufficient at the early stage of starting the vehicle, if some of the air existing in the mixing area (MC) of the air conditioner 100 is supplied to the seat 10, the cooling performance and the heating performance of the seat 10 also get insufficient. As described above, when the heating and cooling performances of the air conditioner 100 are all insufficient at the early stage of starting the vehicle, the thermoelement module or the PTC heater is actuated to cool or heat air rapidly, and then, the cooled or heated air is supplied to the seat 10 to thereby enhance the cooling and heating performances of the seat 10.

In addition, after the cooling and heating performances of the air conditioner 100 are secured sufficiently, the operation of the heat exchanger for seat 153 can be stopped.

Moreover, a seat duct 105 is mounted at an outlet of the seat vent 150 to supply the air passing through the seat vent 150 to the seat 10 of the vehicle.

The seat duct 105 connects the outlet of the seat vent 150 and the seat 10 of the vehicle with each other, and in this instance, an inlet of the seat duct 105 is connected with the outlet of the seat vent 150, but the outlet of the seat duct 105 may be diverged into a number of parts and the diverged parts are connected to the front right and left seats 10 of the vehicle or all seats of the vehicle.

Meanwhile, it is preferable that the seat duct 105 is a flexible variable duct, and so, the air conditioner can supply air to the seat 10 smoothly even though the seat 10 is moved.

Furthermore, a blower for seat 152 is mounted inside the seat vent 150. The blower for seat 152 is mounted at the inlet of the seat vent 150 to forcedly suck the air of the mixing area (MC) of the air-conditioning case 110 and blow the sucked air to the seat 10.

In addition, a door 151 is mounted at the inlet of the seat vent 150 to open or close the inlet of the seat vent 150. It is preferable that the door 151 is mounted on the upstream side of the blower for seat 152.

Moreover, the door 151 minimizes a loss of air volume during air-conditioning the front seat of the vehicle since the door 151 is opened only when the seat 10 is cooled or heated.

Meanwhile, in case that there are a number of the seats 10 to be cooled or heated, as described above, the seat duct 105 is diverged into several parts to cool and heat a number of the seats 10 at the same time, or the air conditioner 100 has a number of the heat exchanger for seat 153 and a number of the blowers for seat 152 mounted inside the seat vent 150 and a number of the seat ducts 105 corresponding to the number of the heat exchanger for seat 153 and the blowers for seat 152 to cool and heat a number of the seats 10.

Additionally, the seat vent 150 according to the present invention is used to cool and heat the seat 10, and the outlet of the seat vent 150 may be connected to a duct for clothing (not shown) to cool and heat clothing. In addition, a variable duct (not shown) is mounted to the outlet of the seat vent 150 and connected to several parts mounted inside the vehicle to be used for various use purposes.

FIG. 5 illustrates a state where the blower for seat is mounted to the seat duct. As shown in the drawing, the blower for seat 152 is mounted inside the seat vent 150, but as shown in FIG. 5, may be mounted on the upstream side of the seat duct 105 mounted on the outside of the air conditioner 100.

That is, just the heat exchanger for seat 153 is mounted inside the seat vent 150 of the air-conditioning case 110, and the blower for seat 152a is mounted on the seat duct 105.

In this instance, in the case that the outlet of the seat duct 105 is diverged into several parts and connected with a number of the seats 10, to supply air to a number of the seats 10 using the one blower for seat 152a, it is preferable that the blower for seat 152a is mounted on the upstream side of the diverged part of the seat duct 105.

Hereinafter, the action of the air conditioner for the vehicles according to the present invention will be described. Additionally, for your convenience, the case that the heat exchanger for seat 153 is configured of the PTC heater will be described.

First, the indoor air or the outdoor air selectively introduced by the blower 103 mounted at the inlet of the air-conditioning case 110 is cooled while passing through the evaporator 101, and the cooled air selectively passes the heater core 102 by the temperature-adjusting door 120.

In this instance, air (hot air) passing through the heater core 102 or air (cold air) bypassing the heater core 102 is mixed in the mixing area (MC), and the mixed air is introduced to each mode door 113a, 114a or 115a according to various air-conditioning modes, flows to each vent 113, 114 or 115, and then, is discharged to the inside of the vehicle to cool or heat the inside of the vehicle.

Meanwhile, when the passenger runs the seat cooling and heating modes to cool and heat the seat 10, the door 151 mounted at the inlet of the seat vent 150 is opened and the blowers for seat 152 and 152a are operated, so that some of the air existing in the mixing area (MC) of the air-conditioning case 110 is supplied to the seat 10 through the seat vent 150 and the seat duct 105 to thereby cool and heat the seat 10.

That is, as described above, when it is difficult to rapidly heat the seat 10 at a low temperature in the winter season, electric power is supplied to the PTC heater, which is the heat exchanger for seat 153, and so, warm air is rapidly supplied to the seat 10. Moreover, when cooling is needed in the summer season, cold air passing through the evaporator 101 of the air conditioner 100 can cool the seat 10.

In addition, when the passenger wants just the air blown from the air conditioner 100, the air existing in the cold air and hot air mixing area (MC) of the air-conditioning case 110 is supplied to the seat 10. In this instance, when heating is needed since the air of the mixing area (MC) is too cold, the PTC heater is actuated to adjust temperature of the air.

As described above, the air conditioner for the vehicles according to the present invention can secure a seat-side space since the air conditioner 100 has the heat exchanger for seat 153 and the blower for seat 152, which are integrated with each other. Moreover, the air conditioner can enhance efficiency, reduce consumption of energy, enhance cooling and heating performances of the seat 10, reduce the number of components and enhance assemblability since the air existing in the mixing area (MC) of the air-conditioning case 110, which is heat-exchanged to the passenger's wanted temperature, is used.

According to the present invention, the air conditioner can secure an installation space of convenient devices mounted inside the seat since the seat vent is formed in the air-conditioning case and the heat exchanger for seat and the blower for seat are formed integrally, and enhance efficiency, reduce consumption of energy and enhance cooling and heating performances of the seat since the air existing in the cold air and hot air mixing area of the air-conditioning case is used and the insufficient heating and cooling load is replenished by the heat exchanger for seat.

Moreover, the air conditioner can reduce the number of components and enhance assemblability since just one heat exchanger for seat and one blower for seat can cool and heat a number of the seats.

Furthermore, the air conditioner does not need additional temperature-adjusting door to adjust temperature of the air supplied to the seat since some of the air existing in the mixing area of the air-conditioning case is supplied to the seat.

Additionally, the air conditioner can be modulated and enhance productivity since the evaporator, the heater core and the heat exchanger for seat are all mounted inside the air conditioner.

In addition, the air conditioner can supply air of the fixed amount to the seat regardless of the air-conditioning modes since some of the air existing in the mixing area of the air-conditioning case is supplied to the seat.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. An air conditioner for vehicles, which comprises: an air-conditioning case having an air introduction port formed at an inlet thereof and a defrost vent, a face vent and a floor vent formed at an outlet thereof; and an evaporator and a heater core mounted inside the air-conditioning case, wherein the air-conditioning case has a seat vent formed at the outlet thereof for supplying some of air existing in a mixing area, where air passing through the evaporator and air passing through the heater core are mixed with each other, to a seat of the vehicle.

2. The air conditioner according to claim 1, wherein a heat exchanger for seat is mounted inside the seat vent to heat-exchange air passing through the seat vent.

3. The air conditioner according to claim 2, wherein a first blower for seat is mounted inside the seat vent.

4. The air conditioner according to claim 2, wherein a seat duct is mounted at an outlet of the seat vent for supplying air to the seat of the vehicle, and a second blower for seat is mounted on the upstream side of the seat duct.

5. The air conditioner according to claim 1, wherein the seat vent is partitionally formed between the right and left sides of the floor vent in such a manner that the floor vent is partitioned into the right and left sides.

6. The air conditioner according to claim 1, wherein a door is mounted at an inlet of the seat vent.
